(19) United States
(12) Patent Application Publication
(10) Pub. No.: US 2018/0156046 A1
(43) Pub. Date: Jun. 7, 2018

(54) ROTOR BLADE FOR A GAS TURBINE

(71) Applicant: Siemens Aktiengesellschaft, Munich (DE)

(72) Inventors: Fathi Ahmad, Kaarst (DE); Nihal Kurt, Düsseldorf (DE); Uwe Paul, Ratingen (DE); Albrecht Rieger, Berlin (DE)

(73) Assignee: Siemens Aktiengesellschaft, Munich (DE)

(21) Appl. No.: 15/575,503

(22) PCT Filed: Apr. 27, 2016
(86) PCT No.: PCT/EP2016/059343

§ 371 Date: Nov. 20, 2017

(30) Foreign Application Priority Data
May 28, 2015 (EP) 15169648.1

(51) Int. Cl. F01D 5/30; F01D 5/14

(52) U.S. Cl. CPC F01D 5/3007; F01D 5/147; F05D 2240/20; F05D 2230/80; F05D 2230/10; F05D 2220/32

(57) ABSTRACT

A rotor blade for a gas turbine, the rotor blade having an aerofoil with a pressure side and an intake side which transition into a platform to which an attachment region is connected, the region having a fir tree spring which has a plurality of lateral toothed extensions arranged on the pressure side and the intake side, which extensions extend in an azimuthal direction. In addition, the azimuthal extent of one lateral toothed extension is reduced in an axial region of the lateral toothed extension, in which region the pressure load during operation exceeds a predefined threshold.

### CROSS REFERENCE TO RELATED APPLICATIONS

This application is the US National Stage of International Application No. PCT/EP2016/059343 filed Apr. 27, 2016, and claims the benefit thereof. The International Application claims the benefit of European Application No. EP15169648 filed May 28, 2015. All of the applications are incorporated by reference herein in their entirety.

### FIELD OF INVENTION

The invention relates to a rotor blade for a gas turbine, comprising a blade airfoil having a pressure side and a suction side that transition into a platform adjoining which is a securing region with a fir-tree key which comprises a plurality of lateral tooth projections arranged on the pressure side and on the suction side and extending in the azimuthal direction. It also relates to methods for producing and for re-working such a rotor blade.

### BACKGROUND OF INVENTION

Rotor blades of the abovementioned type serve in gas turbines for converting the energy of a hot gas stream into rotational energy. They typically have a blade airfoil through which passes one or more cavities for conveying cooling air and which has a concave pressure side and a convex suction side. The blade airfoil transitions into a platform which extends essentially perpendicular thereto and which protects the interior of the rotor from ingress of hot gas. The securing region adjoins the platform and serves to secure the blade to the rotor, namely a turbine disk. The platform and the securing region together form the blade root.

In general, a fir-tree connection is used for securing. This is in essence a variant of a dovetail connection, with a multi-prong dovetail. To that end, the securing region has a straight fir-tree key that extends essentially along the principal direction of extent of the blade airfoil (in general the axial direction; in the following the terms axial, azimuthal or radial always relate to the axis of the gas turbine) and has, on both sides, multiple lateral tooth projections (the prongs of the fir tree). The turbine disk has a corresponding slot for each rotor blade.

Owing to the desire for ever higher efficiency, gas turbine components are exposed to ever higher temperatures and thus thermomechanical loads. In this context, in particular the blade roots and turbine disk slots are subjected to high loads and frequently represent the limiting element with regard to design.

Thus, in order to reduce said loads, WO 2006/124615 A1 discloses slightly flattening off one of the fir-tree tangs at its lateral end. However, this has the drawback that the required precision makes this flattening very laborious.

Furthermore, it is known from JP 63-097803 to reduce the contact surface between the blade roots and the turbine disk slots. In contrast to WO 2006/124615 A1, mentioned above, this reduction does not take place at the lateral ends of the fir-tree tangs but rather at the center thereof, in order to influence the vibration properties of the turbine rotor blade toward more favorable frequencies.

### SUMMARY OF INVENTION

The invention therefore has an object of specifying a rotor blade and a method for producing and for re-working a rotor blade of the type mentioned in the introduction, with which it is possible to achieve increased efficiency and at the same time long service life of the gas turbine and its components.

According to the invention, this object is achieved with regard to the rotor blade in that in an axial region of one lateral tooth projection the azimuthal extent of the lateral tooth projection is reduced, in comparison with the other azimuthal extent of the tooth projection in question.

With regard to the method for producing a rotor blade, the object is achieved with the following steps: —determining a compressive loading of a lateral tooth projection during operation, —determining an axial region of the lateral tooth projection in which the compressive loading during operation exceeds a predetermined threshold, —shaping the lateral tooth projection such that the azimuthal extent of the lateral tooth projection in this axial region is reduced.

With regard to the method for re-working a rotor blade, the object is achieved with the following steps: —determining a compressive loading of a lateral tooth projection during operation, —determining an axial region of the lateral tooth projection in which the compressive loading during operation exceeds a predetermined threshold, —machining the lateral tooth projection such that the azimuthal extent of the lateral tooth projection in this axial region is reduced.

In that context, the invention proceeds from the consideration that efficiency and lifespan are increased if the loads—arising from the increase in rotational speed and temperature—are distributed evenly onto the highly loaded regions such as the already-mentioned blade roots and turbine wheel slots. In this context, the loads are due essentially to the centrifugal and aerodynamic forces on the blade airfoil. In this context, it has proven that in most known fir-tree designs there is an extremely uneven pressure distribution on the lateral tooth projections, both with regard to the pressure and suction side and with regard to the axial and radial arrangement of the respective tooth projection on the fir-tree key. Thus, these regions subjected to high compressive loading are frequently the bottleneck in terms of lifespan of the rotor blade root and of the turbine wheel slots. Here, the compressive loading can be reduced by, in the case of an unchanged straight slot shape, reducing the azimuthal extent of those regions of a tooth projection that are subjected to high compressive loading. This produces a small gap between this region and the lateral slot wall, so that in the event of compressive loading no force can at first act here, and thus the effect of the force is shifted to the less-loaded regions. A force can act here only once elastic deformation owing to the pressure has caused the gap to close during operation.

In the production process, these regions subjected to high compressive loading are first determined for example by testing measurements or by computational simulations. It is thus possible to locate in a targeted manner the regions which are subjected to compressive loading and in which a reduction in the azimuthal extent of the tooth projections is indicated. These are then accordingly shaped directly in the production process, for example by adapting the casting mold. Alternatively, a tooth projection which is of constant azimuthal extent over its entire axial length can, in the course of re-working, be machined in the appropriate regions, for example using a laser or using mechanical (e.g. chip-removing) methods.

In an advantageous embodiment of the rotor blade, the lateral tooth projection, of which the azimuthal extent is reduced, is arranged on the suction side of the rotor blade. Here, specifically, the pressure is particularly high, owing in particular to the aerodynamic forces on the rotor blade, so that here an even distribution is required and is particularly efficient with regard to increased lifespan.

In another advantageous embodiment of the rotor blade, the azimuthal extent of the lateral tooth projection furthest removed from the platform is reduced. The lever effect means that the pressure is particularly high in particular in the region furthest removed from the platform and from the blade airfoil.

In the case of a rotor blade which is designed for an insertion direction parallel to the axial direction of the gas turbine, the axial region advantageously comprises the axial center of the lateral tooth projection. In the case of rotor blades of that type, which are designed for insertion into the slots of the turbine disk parallel to the axial direction, that is to say that the so-called stagger angle is equal to 0°, the maximum load occurs axially centrally.

In a still more advantageous embodiment, in the case of rotor blades of that type, the azimuthal extent of the lateral tooth projection is symmetric with respect to the axial center thereof since the compressive load is even symmetric with respect to the axial center.

By contrast, in the case of a rotor blade which is designed for an insertion direction inclined with respect to the axial direction, the axial region is advantageously arranged outside the axial center of the lateral tooth projection. In the case of rotor blades of that type, which are designed for insertion into the slots of the turbine disk at an angle to the axial direction, that is to say that the so-called stagger angle is not equal to and generally greater than 0°, the maximum load does not namely occur axially centrally, but rather in the direction of the end faces.

Advantageously, the axial region has a concave contour in the axial direction. This makes it particularly well-suited to compressive loading arising during operation.

In a still more advantageous embodiment, in rotor blades of this type, the axial region has a longitudinal extent in the axial direction that is greater than the depth of the axial region as can be measured in the azimuthal direction. This also leads to improved compressive loading.

In a further advantageous embodiment, both of the rotor blade and of the methods, the azimuthal extent at a point in the region of the lateral tooth projection is a function, in particular a monotonic function, of the compressive loading during operation. With regard to the methods, the lateral tooth projection is shaped or machined accordingly. In other words: The greater the determined compressive loading at a point on the lateral tooth projection, the greater the reduction in azimuthal extent at this point. This achieves the best possible smoothing of the compressive loading.

A rotor for a gas turbine advantageously comprises such a rotor blade and/or a rotor blade produced or re-worked with the respective described method.

A gas turbine advantageously comprises such a rotor.

The advantages achieved with the invention consist in particular in that due to the width of the tooth projections of the fir-tree key, of which the cross section is otherwise constant in the axial direction, being reduced in regions subjected to particular compressive loading, the compressive loading during operation is evened out and thus the lifespan of the rotor blade is increased. Such a reduction in the azimuthal extent can also be carried out retrospectively on rotor blades that are already in use in almost all gas turbines, such that it is possible to increase the lifespan in this context too. Special re-working tools are not required: standard tools can be used.

### BRIEF DESCRIPTION OF THE DRAWINGS

The invention will be explained in greater detail with reference to drawings, in which:

FIG. 1 shows a partial view of a rotor blade having a fir-tree key in the securing region with reduced azimuthal extent of the tooth projections on the pressure side,

FIG. 2 shows a side view of the rotor blade with isobaric illustration of the compressive loading during operation, and

FIG. 3 shows a partial longitudinal section through a gas turbine.

### DETAILED DESCRIPTION OF INVENTION

In all figures, the same parts have been provided with the same reference signs.

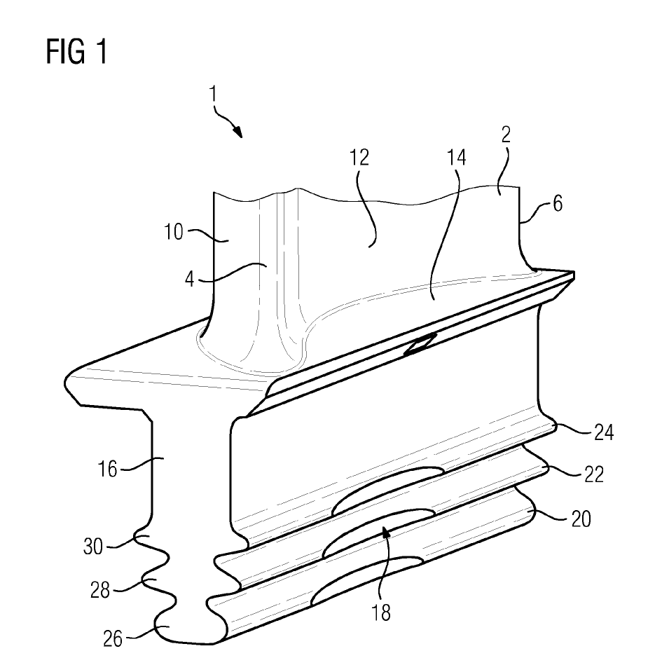

FIG. 1 shows a rotor blade 1 for a gas turbine. The rotor blade 1 has, first of all, a straight blade airfoil 2, only part of which is shown. The profile of the blade airfoil 2 resembles that of an airplane wing. It has a rounded leading edge 4 and a trailing edge 6. The convex suction side 10 (at the back of FIG. 1) and the concave pressure side 12 of the rotor blade 1 extend between the leading edge 4 and the trailing edge 6.

The rotor blade root, which first comprises the platform 14, adjoins the blade airfoil 2. The platform 14 serves to seal the rotor of the gas turbine against the hot gas flowing around the rotor blade 1. Adjoining the platform 14 and also as part of the rotor blade root is the securing region 16. This consists essentially of a fir-tree key 18 by means of which the rotor blade 1 is fixed in a corresponding slot in the turbine disk in a fir-tree-like slot-and-key connection.

The fir-tree key 18 tapers in the axial direction in the direction away from the platform 14, that is to say radially inwards, and has on each side, that is to say both on the pressure side 12 and on the suction side 10, three parallel tooth projections 20, 22, 24, 26, 28, 30 extending in the azimuthal direction. In that arrangement, the cross section of the fir-tree key 18 is essentially constant in the axial direction.

However, in a departure from this latter constancy, the azimuthal extent of the tooth projections 22, 24, 26 is reduced in a region of the three tooth projections 22, 24, 26 that is symmetrically central with respect to the axial extent of the fir-tree key 18 and extends approximately over one third of the axial extent thereof. In particular, in this region the compressive loading during operation is greater than a predefined threshold. Reducing the azimuthal extent reduces the load on this region. The contour of the reduction is essentially concave, its longitudinal extent being greater than the depth of the reduction as can be measured in the azimuthal direction.

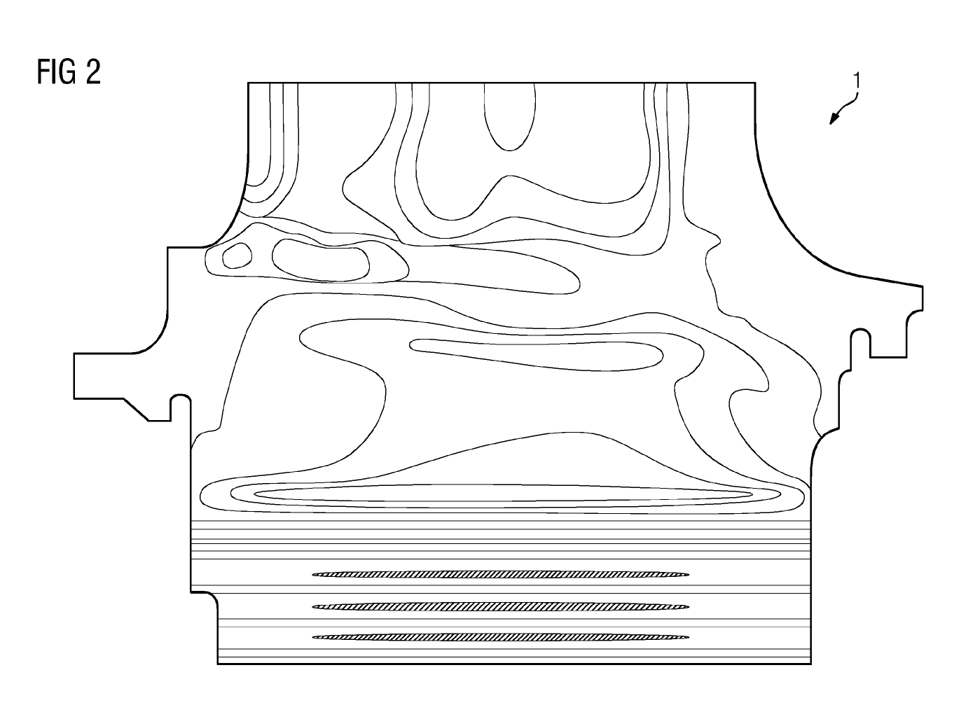

FIG. 2 shows this compressive loading, as determined by means of a simulation, on a fir-tree key 18 without a reduction in the azimuthal extent of the tooth projections 22, 24, 26. FIG. 2 shows isobars here, and therefore for the sake of clarity the only reference sign included is that of the rotor blade 1. In the stated central region of the tooth projections 22, 24, 26, the compressive loading is greatest overall, namely close to 1000 MPa during operation. A suitable threshold value could in this context be for example 700 MPa, but can be chosen appropriately by a person skilled in the art.

It can also be seen that, in the axial direction, the compressive loading increases from the outer edges toward the middle, and also with increasing distance of the tooth projection 20, 22, 24 from the platform 14. Accordingly, the region of the reduction of the azimuthal extent of the tooth projections 20, 22, 24 in FIG. 1 is modeled on this distribution of the compressive loading; the degree of reduction is therefore a function of the compressive loading: The reduction is most pronounced at the axial center and becomes less so toward the edge of the region. At the same time, the reduction is in each case more pronounced with increasing distance of the tooth projection 20, 22, 24.

The illustrated reduction of the azimuthal extent of the tooth projections 20, 22, 24 of the rotor blade 1 in FIG. 1 is introduced in the production process, e.g. directly during casting of the rotor blade 1, but can also be effected by re-working using chip-removing methods, or by machining using lasers. In that context, the compressive loading is determined beforehand by simulation or other means, for example by means of appropriate testing arrangements.

The rotor blade 1 shown in FIG. 1 is designed for an insertion direction, that is to say the orientation of the slot in the turbine disk, parallel to the axial direction. To that end, for example, right angles are provided between the end faces and the side faces of the fir-tree key 18. In one embodiment of the rotor blade 1 which is not shown, the rotor blade is intended for an insertion direction that is inclined with respect to the axial direction, in that context the so-called stagger angle is greater than 0°. In such a rotor blade 1, the region in which the reduction in the azimuthal extent of the tooth projections 20, 22, 24 is arranged is not arranged symmetrically about the axial center. Rather, this region is shifted toward one of the end faces and may not even include the center.

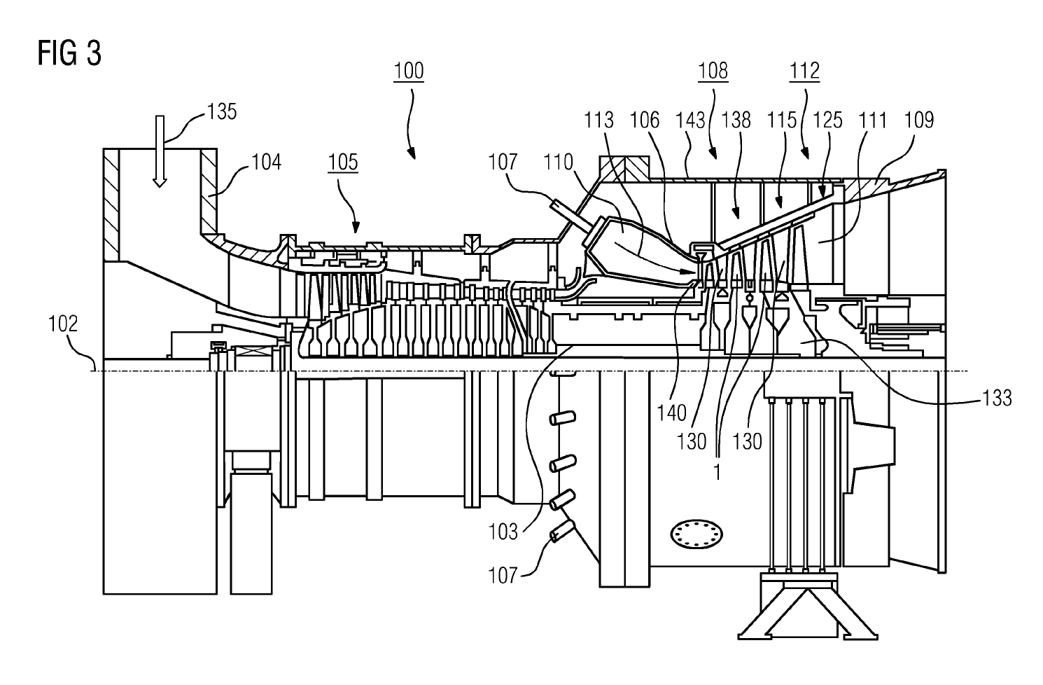

Finally, FIG. 3 shows a partial longitudinal section through a gas turbine 100. A turbine is a turbomachine which converts the internal energy (enthalpy) of a flowing fluid (liquid or gas) into rotational energy and finally into mechanical drive energy.

In the interior, the gas turbine 100 has a rotor 103 which is mounted such that it can rotate about an axis of rotation 102 (axial direction) and is also referred to as the turbine rotor. An intake housing 104, a compressor 105, a toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with an annular hot gas duct 111. There, four series-connected turbine stages 112 form the turbine 108. Each turbine stage 112 is formed from two blade rings. As seen in the direction of flow of a working medium 113, in the hot gas duct 111 a row of stator blades 115 is followed by a row 125 of rotor blades 1. The blades 120, 130 have a slightly curved profile, similar to an airplane wing.

In that context, the stator blades 130 are secured to the stator 143, whereas the rotor blades 1 of a row 125 are fitted to the rotor 103 by means of a turbine disk 133. The rotor blades 1 are thus a constituent part of the rotor or spool 103. A generator or a working machine (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot gas duct 111 past the stator blades 130 and the rotor blades 1.

As the fluid flow flows—as turbulence-free and laminar as possible—around the turbine blades 1, 130, part of the internal energy of the fluid flow is extracted therefrom and is taken up by the rotor blades 1 of the turbine 108. These then set the rotor 103 in rotation, first driving the compressor 105. The useful power is provided to the generator (not shown).

While the gas turbine 100 is operating, the components which are exposed to the hot working medium 113 are subject to thermal stresses. The stator blades 130 and rotor blades 1 of the first turbine stage 112, as seen in the direction of flow of the working medium 113, together with the heat shield tiles which line the annular combustion chamber 106, are subject to the highest thermal stresses. The high loads require extremely resistant materials. The turbine blades 1, 130 are therefore made of titanium alloys, nickel superalloys or tungsten-molybdenum alloys. In order to increase their resistance with respect to temperatures and erosion such as pitting, the blades are protected by means of coatings against corrosion (MCrAlX; M=Fe, Co, Ni, rare earths) and heat (thermal barrier coating, for example ZrO2, Y2O4-ZrO2). The coating for heat protection is termed thermal barrier coating or TBC for short. Other measures to provide the blades with greater heat resistance consist of sophisticated cooling channel systems. This technique is used both in stator blades and in rotor blades 1, 130.

Each stator blade 130 has a stator blade root (not shown here), also termed platform, which faces the inner casing 138 of the turbine 108, and a stator blade tip, which is at the opposite end from the stator blade root. The stator blade tip faces the rotor 103 and is fixed to a sealing ring 140 of the stator 143. In that context, each sealing ring 140 surrounds the shaft of the rotor 103. Also, each rotor blade 1 has such a rotor blade root but ends in a rotor blade tip. This tip is configured in accordance with the embodiment shown in FIG. 1.

1. A rotor blade for a gas turbine, comprising:
a blade airfoil having a pressure side and a suction side that transition into a platform adjoining which is a securing region with a fir-tree key which comprises a plurality of lateral tooth projections arranged on the pressure side and on the suction side and extending in the azimuthal direction,
wherein in an axial region of one lateral tooth projection the azimuthal extent of the lateral tooth projection is reduced.

2. The rotor blade as claimed in claim 1,
in which the lateral tooth projection is arranged on the suction side of the rotor blade.

3. The rotor blade as claimed in claim 1,
in which the azimuthal extent of the lateral tooth projection furthest removed from the platform is reduced.

4. The rotor blade as claimed in claim 1,
which is designed for an insertion direction parallel to the axial direction,
wherein the axial region comprises the axial center of the lateral tooth projection.

5. The rotor blade as claimed in claim 4,
in which the azimuthal extent of the lateral tooth projection is symmetric with respect to the axial center thereof.

6. The rotor blade as claimed in claim 1,
which is designed for an insertion direction inclined with respect to the axial direction,
wherein the axial region is arranged outside the axial center of the lateral tooth projection.

7. The rotor blade as claimed in claim 1,
in which the azimuthal extent at a point in the region of the lateral tooth projection is a function of the compressive loading during operation.

8. The rotor blade as claimed in claim 1,
which is designed for an insertion direction parallel to the axial direction,
wherein the axial region has a concave contour in the axial direction.

9. The rotor blade as claimed in claim 1,
which is designed for an insertion direction parallel to the axial direction,
wherein the axial region has a longitudinal extent in the axial direction that is greater than the depth of the axial region as measured in the azimuthal direction.

10. A method for producing a rotor blade for a gas turbine, comprising a blade airfoil having a pressure side and a suction side that transition into a platform adjoining which is a securing region with a fir-tree key which comprises a plurality of lateral tooth projections arranged on the pressure side and on the suction side and extending in the azimuthal direction, the method comprising:
determining a compressive loading of a lateral tooth projection during operation,
determining an axial region of the lateral tooth projection in which the compressive loading during operation exceeds a predetermined threshold,
shaping the lateral tooth projection such that the azimuthal extent of the lateral tooth projection in this axial region is reduced.

11. The method as claimed in claim 10,
in which the lateral tooth projection is shaped such that the azimuthal extent at a point in the region of the lateral tooth projection is a function of the compressive loading during operation.

12. A method for re-working a rotor blade for a gas turbine, comprising a blade airfoil having a pressure side and a suction side that transition into a platform adjoining which is a securing region with a fir-tree key which comprises a plurality of lateral tooth projections arranged on the pressure side and on the suction side and extending in the azimuthal direction, the method comprising:
determining a compressive loading of a lateral tooth projection during operation,
determining an axial region of the lateral tooth projection in which the compressive loading during operation exceeds a predetermined threshold,
machining the lateral tooth projection such that the azimuthal extent of the lateral tooth projection in this axial region is reduced.

13. The method as claimed in claim 12,
in which the lateral tooth projection is machined such that the azimuthal extent at a point in the region of the lateral tooth projection is a function of the compressive loading during operation.

14. A rotor comprising:
a rotor blade as claimed in claim 1.

15. A gas turbine comprising:
a rotor as claimed in claim 14.

16. A rotor comprising:
a rotor blade produced according to the method as claimed in claim 10.

17. A rotor comprising:
a rotor blade re-worked according to the method as claimed in claim 12.

18. A gas turbine comprising:
a rotor as claimed in claim 16.

19. A gas turbine comprising:
a rotor as claimed in claim 17.
